(19) United States
(12) Patent Application Publication
(10) Pub. No.: US 2016/0121651 A1
(43) Pub. Date: May 5, 2016

(54) CASTER ASSEMBLY

(71) Applicant: Warren Won Choi, (US)

(72) Inventor: Warren Won Choi, (US)

(21) Appl. No.: 14/530,578

(22) Filed: Oct. 31, 2014

(51) Int. Cl. B60B 33/00

(52) U.S. Cl. CPC B60B 33/0028

(57) ABSTRACT

A caster assembly includes a caster support leg, a protective shell, a wheel and an axle bolt. The protective shell has a caster support leg housing to receive the caster support leg therein and a sloped side, and the wheel has a tread, a hub and a bearing. The axle bolt secures the caster support leg and the protective shell to the wheel. The caster support leg housing has an upper base, a lower base, and a side wall. The upper base is substantially flat and parallel to the axis of the hub whereas the lower base extends flat from an end of the side wall to form a flat portion and then downwardly sloped toward an inlet of the caster support leg housing. In addition, the sloped side extends downwardly from the upper base toward the tread of the wheel.

### CROSS-REFERENCE TO RELATED APPLICATIONS

Not applicable.

### FIELD OF THE INVENTION

The present invention relates to a caster assembly, and more specifically, a caster assembly having a caster support leg and a protective shell. The protective shell has a caster support leg housing to receive the caster support leg therein and a sloped side.

### BACKGROUND OF THE INVENTION

A caster is a wheel or rotating ball mounted in a swivel frame having caster support legs. Casters are expected to support and withstand large loads and casters need to be fabricated economically because they are used in very large quantities. In addition, casters need to be designed to prevent entrance of a foreign substance such as dust, trash, threads, shavings or the like into the interior of the caster.

Accordingly, casters need to have simple structure to withstand heavy loads and prevent entrance of a foreign substance into the interior of the caster.

Therefore, there is a need for a caster assembly having a caster support leg and a protective shell such that the protective shell has a caster support leg housing to receive the caster support leg therein and a sloped side. This invention is directed to solve these problems and satisfy the long-felt need.

### SUMMARY OF THE INVENTION

The present invention contrives to solve the disadvantages of the prior art. The present invention provides a caster assembly.

The object of the invention is to provide a caster assembly, having a caster support leg, a protective shell, a wheel and an axle bolt. The protective shell has a caster support leg housing to receive the caster support leg therein and the caster support leg snugly or tightly fits in the caster support leg housing.

Another object of the invention is to provide a caster assembly, having a caster support leg, a protective shell, a wheel and an axle bolt. The protective shell has a caster support leg housing to receive the caster support leg therein and a sloped side, and the wheel has a tread, a hub and a bearing. The axle bolt secures the caster support leg and the protective shell to the wheel. The caster support leg housing has an upper base, a lower base, and a side wall. The upper base is substantially flat and parallel to the axis of the hub whereas the lower base extends flat from an end of the side wall to form a flat portion and then downwardly sloped toward an inlet of the caster support leg housing. In addition, the sloped side extends downwardly from the upper base toward the tread of the wheel.

Still another object of the invention is to provide a caster assembly. The protective shell has a caster support leg housing to receive the caster support leg therein and the caster support leg housing comprises an upper base, a lower base, and a side wall. The caster support leg housing further comprises a raised ridge formed downwardly on the upper base and the caster support leg is snuggly and tightly secured between the raised ridge and the flat portion of the lower base.

The advantages of the present invention are: (1) the caster assembly of the present invention is constructed to securely fasten a caster support leg to a wheel using a protective shell; (2) it is easy and convenient to attach and securely affix the caster support leg to the wheel; (3) the caster assembly of the present invention prevents a foreign substance such as dust, trash, threads, shavings or the like from entering interior of the caster assembly; (4) the caster assembly of the present invention has a simple but effective structure and its manufacturing cost is low; and (5) the protective shell of the caster assembly protects the caster from damages.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 shows a front view of the caster assembly of the present invention;

FIG. 2 shows a perspective view of the caster assembly of the present invention;

FIG. 3 shows an exploded view of the caster assembly of the present invention;

FIG. 4(a) shows a perspective view of the protective shell of the caster assembly according to one embodiment of the present invention;

FIG. 4(b) shows a plan view of the protective shell of the caster assembly according to one embodiment of the present invention;

FIG. 4(c) shows a side view of the protective shell of the caster assembly according to one embodiment of the present invention;

FIG. 4(d) shows a cross-sectional view of the protective shell of the caster assembly according to one embodiment of the present invention;

FIG. 4(e) shows a cross-sectional view of the protective shell of the caster assembly according to another embodiment of the present invention;

FIG. 4(f) shows a cross-sectional view of the protective shell of the caster assembly according to still another embodiment of the present invention;

FIG. 4(g) shows a rear perspective view of the protective shell according to one embodiment of the present invention;

FIG. 5(a) shows a plan view of the wheel of the present invention; and

FIG. 5(b) shows a cross-sectional view of the wheel of the present invention.

### DETAILED DESCRIPTION EMBODIMENTS OF THE INVENTION

Reference will now be made in detail to the preferred embodiments of the present invention, examples of which are illustrated in the accompanying drawings, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention.

As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

In the following detailed description, reference is made to the accompanying drawings which form a part hereof, and in which are shown by way of illustration specific embodiments in which the subject matter disclosed herein may be practiced. These embodiments, which are also referred to herein as “examples,” are described in sufficient detail to enable those skilled in the art to practice the subject matter disclosed herein. It is to be understood that the embodiments may be combined or that other embodiments may be utilized, and that structural, logical, and electrical variations may be made without departing from the scope of the subject matter disclosed herein. The following detailed description is, therefore, not to be taken in a limiting sense, and the scope of the subject matter disclosed herein is defined by the appended claims and their equivalents. In the description that follows, like numerals or reference designators will be used to refer to like parts or elements throughout. In this document, the term “or” is used to refer to a nonexclusive or, unless otherwise indicated. Moreover, unless explicitly stated to the contrary, embodiments “comprising” or “having” an element or a plurality of elements having a particular property may include additional such elements not having that property.

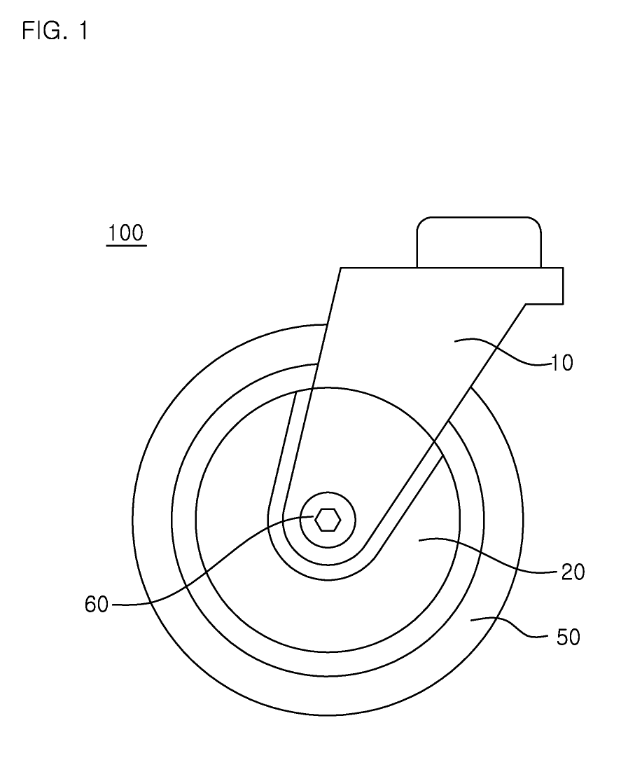

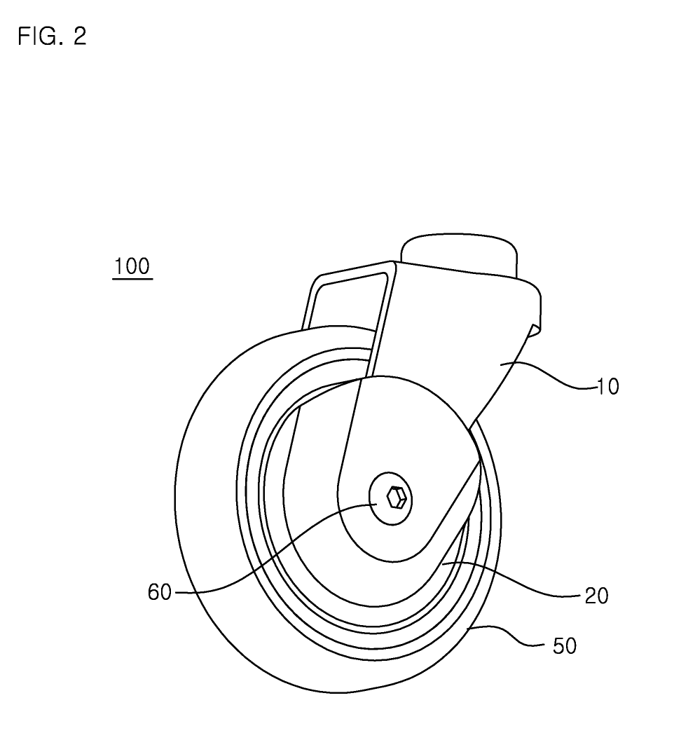

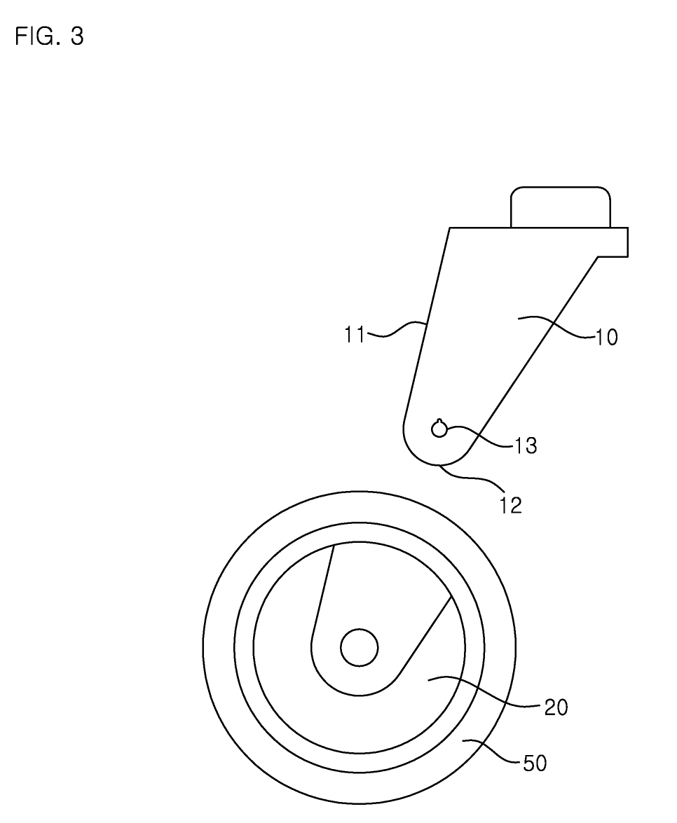

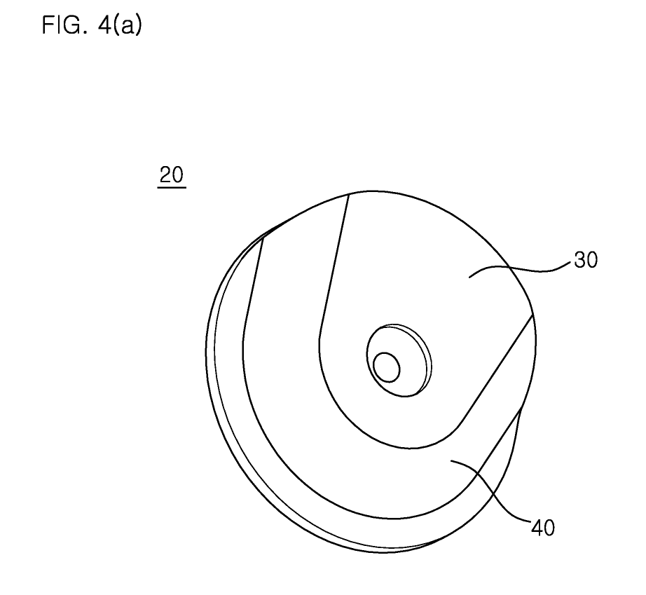

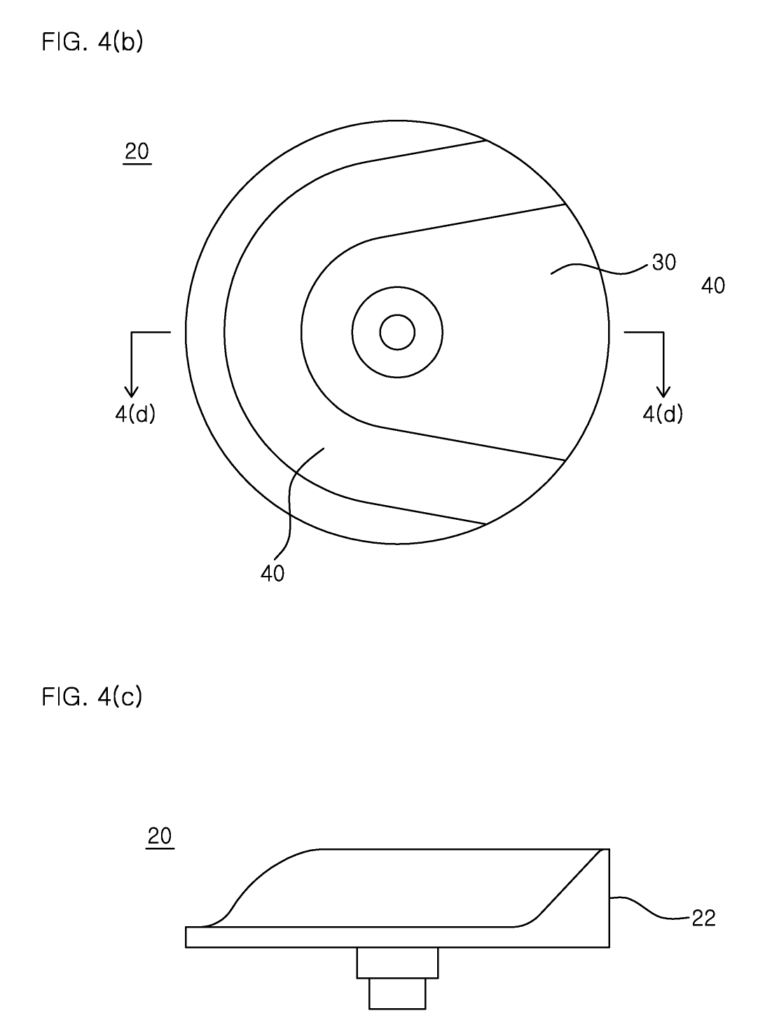

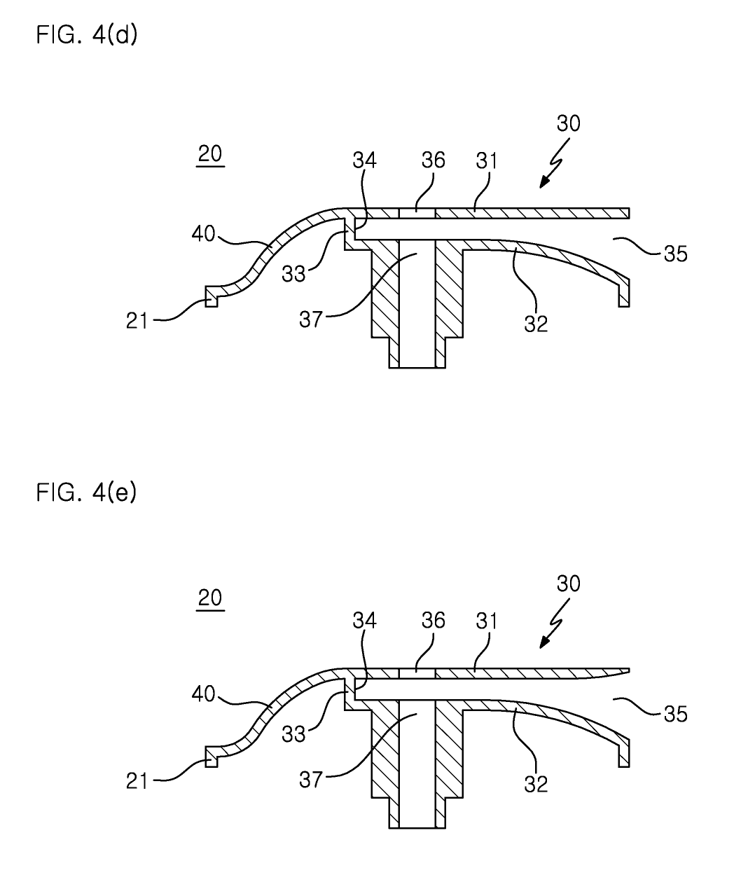

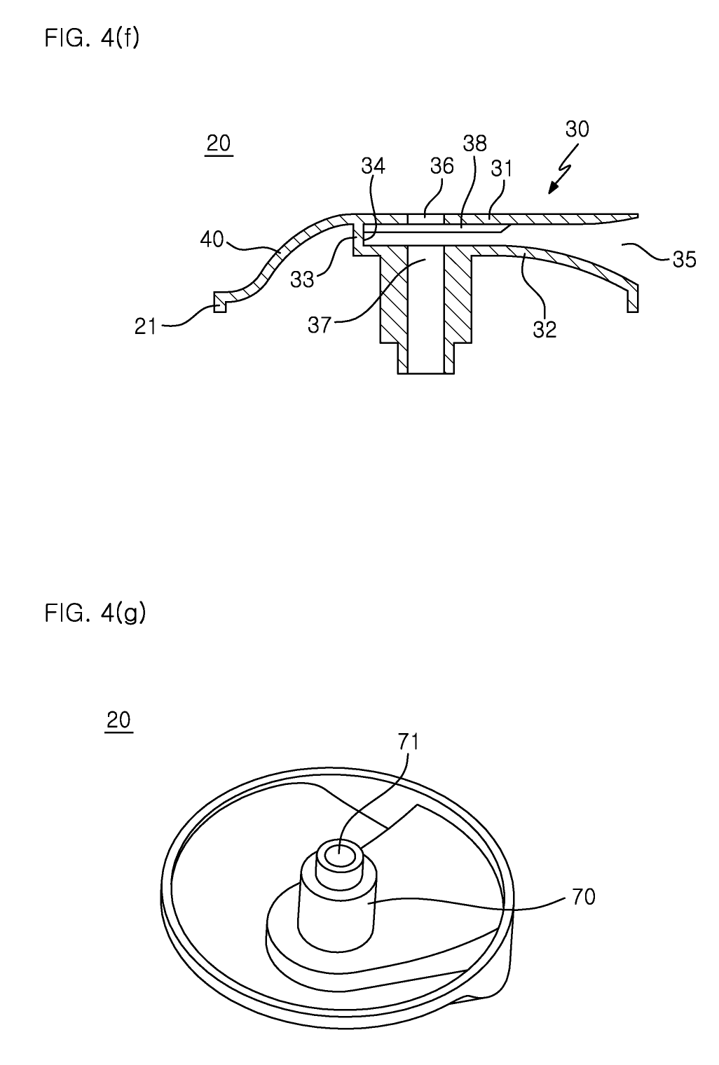

FIGS. 1 and 2 respectively show front and perspective views of the caster assembly 100 according to the present invention. FIG. 3 shows an exploded view of the caster assembly 100 such that the caster support leg 10 is detached from the protective shell 20. In addition, FIGS. 4(a) and 4(d) respectively show perspective and cross-sectional views of the protective shell 20.

The caster assembly 100 includes a caster support leg 10; a protective shell 20 which has a caster support leg housing 30 to receive the caster support leg therein and a sloped side 40; a wheel 50 which has a tread 51, a hub 53 and a bearing 54, and an axle bolt 60 to secure the caster support leg 10 and the protective shell 20 to the wheel 50. As shown in FIG. 4(d), the caster support leg housing 30 has an upper base 31, a lower base 32, and a side wall 33. The upper base 31 is substantially flat and parallel to an axis (a) of the hub 53 whereas the lower base 32 extends flat from an end 34 of the side wall 33 to form a flat portion and then downwardly sloped toward an inlet 35 of the caster support leg housing 30. In addition, the sloped side 40 extends downwardly from the upper base 31 toward the tread 51 of the wheel 50. The structure by the sloped side 40 prevents a foreign substance from entering the interior of the caster assembly 100.

While rotating, the wheel 50 may pick up a foreign substance which may be entangled around the wheel, but the structure of the protective shell 20 prevents such entanglement.

An upper axle bolt hole 36 is formed on the upper base 31 to receive a head of the axle bolt 60 or a nut to be fastened to the axle bolt 60 and a lower axle bolt hole 37 is formed on the lower base 32 to receive the axle bolt 60. The caster support leg 10 snugly or tightly fits in the caster support leg housing 30. More specifically, the caster support leg 10 is snuggly or tightly secured between the upper base 31 and the flat portion of the lower base 32. Preferably, both of upper and lower surfaces of the upper base 31 are substantially flat.

The protective shell 20 may further comprise an annular flange 21 formed on an edge of the protective shell 20 and extending toward the hub 53. The annular flange 21 prevents a foreign substance such as dust, trash, threads, shavings or the like from entering the space between the wheel 50 and the protective shell 20.

As shown in FIGS. 1-3, the caster support leg 10 tapers toward an end of the support leg 10 to form a taper 11 and the end of the support leg is rounded to form a rounded end 12. The upper and lower bases 31 and 32 and the side wall 33 conform to the taper 11 and rounded end 12 of the caster support leg 10 so that the caster support leg 10 snuggly fits in the caster support leg housing 30. The caster support leg 10 further includes an axle bolt hole 13 to receive the axel bolt.

FIG. 4(b) shows a plan view of the protective shell 20. In addition, FIGS. 4(c) and 4(g) respectively show front and rear perspective views of the protective shell 20 according to one embodiment of the present invention.

The protective shell 20 further includes a sleeve 70 extending from the lower base 32 towards the bearing 54 of the wheel 50 and an axle bolt opening 71 is formed in the sleeve 70 to receive the axle bolt 60. An end of the sleeve 70 is engaged with an inner race 56 of the bearing 54 by a friction fit. Beside, the protective shell 20 may further include a perpendicular side 22 such that the perpendicular side 22 is circular and substantially perpendicular to the axis (a) of the hub 53.

FIG. 4(e) shows a cross-sectional view of the protective shell of the caster assembly according to another embodiment of the present invention. Here, the upper surface of the upper base 31 is substantially flat. However, the lower surface of the upper base 31 extends flat from the end 34 of the side wall 33 and then upwardly sloped toward the inlet 35 of the caster support leg housing 30. Because of this configuration, the caster support leg 10 can be, conveniently without interruption, inserted into the caster support leg housing 30. Once inserted, the caster support leg 10 is secured to the flat portion of the lower surface of the upper base 31.

FIG. 4(f) shows still another embodiment of the protective shell 20. Here, the caster support leg housing 30 further comprises a raised ridge 38 formed downwardly on the upper base 31 and the caster support leg 10 is snuggly and tightly secured between the raised ridge 38 and the flat portion of the lower base 32. The raised ridge 38 extends flat from the end of the side wall and then upwardly sloped toward the inlet 35 of the caster support leg housing 30. Preferably, there are two raised ridges 38 formed on opposite sides of the upper axle bolt hole 36.

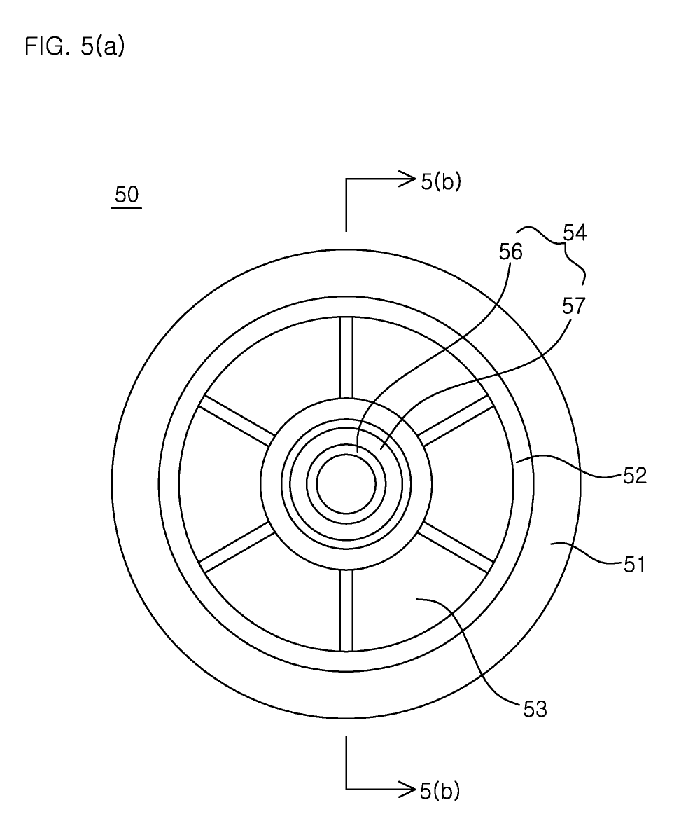

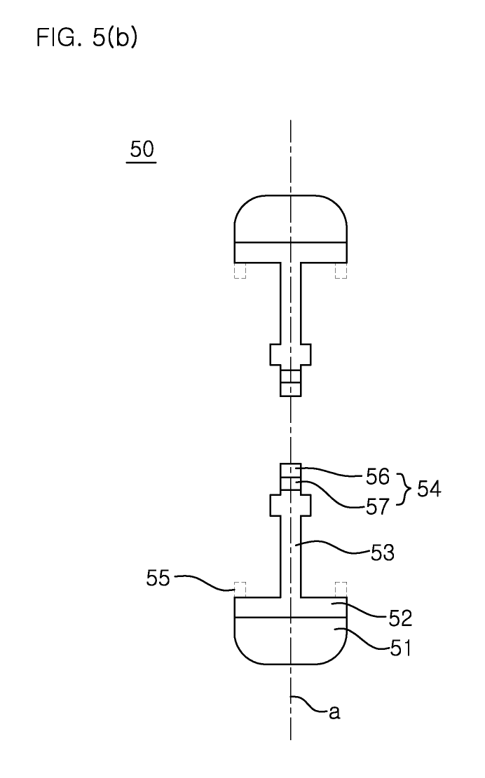

FIGS. 5(a) and 5(b) respectively show plan and cross-sectional views of the wheel 50.

The wheel 50 has a tread 51, a hub 53 and a bearing 54 and it 50 may further comprise an annular tread support 52 for supporting the tread 51 and formed in between the tread 51 and the hub 53. Preferably, the outer edge of the annular tread support 52 extends beyond an edge of the sloped side 40 of the protective shell 20 in order to prevent a foreign substance such as dust, trash, threads, shavings or the like from entering the space between the wheel 50 and the protective shell 20.

The annular tread support 52 may include a semi-annular ridge 55 formed on an outer edge of the annular tread support 52 toward an inner side of the wheel 50. In addition, the semi-annular ridge 55 may cover an edge of the sloped side 40 of the protective shell 20.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A caster assembly 100, comprising:
a caster support leg 10;
a protective shell 20 which has a caster support leg housing 30 to receive the caster support leg therein and a sloped side 40;
a wheel 50 which has a tread 51, a hub 53 and a bearing 54, and
an axle bolt 60 to secure the caster support leg 10 and the protective shell 20 to the wheel 50, wherein the caster support leg housing 30 comprises an upper base 31, a lower base 32, and a side wall 33, wherein the upper base 31 is substantially flat and parallel to an axis (a) of the hub 53, wherein the sloped side 40 extends downwardly from the upper base 31 toward the tread 51 of the wheel 50, wherein the lower base 32 extends flat from an end 34 of the side wall 33 to form a flat portion and then downwardly sloped toward an inlet 35 of the caster support leg housing 30.

2. The caster assembly of claim 1, an upper axle bolt hole 36 is formed on the upper base 31 to receive a head of the axle bolt 60 or a nut to be fastened to the axle bolt 60 and a lower axle bolt hole 37 is formed on the lower base 32 to receive the axle bolt 60.

3. The caster assembly of claim 2, wherein the caster support leg 10 snugly or tightly fits in the caster support leg housing 30.

4. The caster assembly of claim 3, wherein the caster support leg 10 is snuggly or tightly secured between the upper base 31 and the flat portion of the lower base 32.

5. The caster assembly of claim 3, wherein both an upper surface and a lower surface of the upper base 31 are substantially flat.

6. The caster assembly of claim 3, wherein an upper surface of the upper base 31 is substantially flat and the lower surface of the upper base 31 extends flat from the end 34 of the side wall 33 and then upwardly sloped toward the inlet 35 of the caster support leg housing 30.

7. The caster assembly of claim 3, wherein the caster support leg housing 30 further comprises a raised ridge 38 formed downwardly on the upper base 31 and the caster support leg 10 is snuggly and tightly secured between the raised ridge 38 and the flat portion of the lower base 32.

8. The caster assembly of claim 7, wherein the raised ridge 38 extends flat from the end of the side wall and then upwardly sloped toward the inlet 35 of the caster support leg housing 30.

9. The caster assembly of claim 8, wherein there are two raised ridges 38 formed on opposite sides of the upper axle bolt hole 36.

10. The caster assembly of claim 1, wherein the caster support leg 10 tapers toward an end of the support leg 10 to form a taper 11 and the end of the support leg is rounded to form a rounded end 12.

11. The caster assembly of claim 10, wherein the upper and lower bases 31 and 32 and the side wall 33 conform to the taper 11 and rounded end 12 of the caster support leg 10.

12. The caster assembly of claim 10, wherein the caster support leg 10 further comprises an axle bolt hole 13 to receive the axel bolt.

13. The caster assembly of claim 1, wherein the protective shell 20 further comprises an annular flange 21 formed on an edge of the protective shell 20 and extending toward the hub 53.

14. The caster assembly of claim 13, wherein the wheel 50 further comprises an annular tread support 52 for supporting the tread 51 and formed in between the tread 51 and the hub 53.

15. The caster assembly of claim 14, wherein an outer edge of the annular tread support 52 extends beyond an edge of the sloped side 40 of the protective shell 20.

16. The caster assembly of claim 14, wherein the annular tread support 52 comprises a semi-annular ridge 55 formed on an outer edge of the annular tread support 52 toward an inner side of the wheel 50.

17. The caster assembly of claim 16, wherein the semi-annular ridge 55 covers an edge of the sloped side 40 of the protective shell 20.

18. The caster assembly of claim 1, wherein the protective shell 20 further comprises a sleeve 70 extending from the lower base 32 towards the bearing 54 of the wheel 50 and an axle bolt opening 71 is formed in the sleeve 70 to receive the axle bolt 60.

19. The caster assembly of claim 18, wherein an end of the sleeve 70 is engaged with an inner race 56 of the bearing 54 by a friction fit.

20. The caster assembly of claim 1, wherein the protective shell 20 further comprises a perpendicular side 22 wherein the perpendicular side 22 is circular and substantially perpendicular to the axis (a) of the hub 53.
